(19) United States
(12) Patent Application Publication
(10) Pub. No.: US 2025/0035736 A1
(43) Pub. Date: Jan. 30, 2025

(54) METHOD AND SYSTEM FOR BEAM MANAGEMENT FOR INTEGRATED SENSING AND COMMUNICATION

(71) Applicant: Samsung Electronics Co., Ltd., Gyeonggi-do (KR)

(72) Inventors: Liang HU, San Diego, CA (US); Philippe Jean Marc Michel SARTORI, Naperville, IL (US); Jung Hyun BAE, San Diego, CA (US)

(21) Appl. No.: 18/784,333

(22) Filed: Jul. 25, 2024

Related U.S. Application Data
(60) Provisional application No. 63/515,969, filed on Jul. 27, 2023.

(51) Int. Cl. G01S 7/00; G01S 13/42

(52) U.S. Cl. CPC G01S 7/006; G01S 13/42

(57) ABSTRACT

Methods and devices of a wireless system are provided. A first device of the wireless system receives a first set of sensing reference signals (RSs) over beams from a second device, performs first beam measurements based on the first set of sensing RSs, and transmits, to the second device, a first information report based on the beam measurements. The first information report includes a first type of sensing information. The first device also receives, from the second device, a second set of sensing RSs, performs second beam measurements based on the second set of sensing RSs, and transmits, to the second device, a second information report based on the second beam measurements. The second information report includes a second type of sensing information that is different from the first type of sensing information.

### CROSS-REFERENCE TO RELATED APPLICATION

This application claims the priority benefit under 35 U.S.C. § 119 (c) of U.S. Provisional Application No. 63/515,969, filed on Jul. 27, 2023, the disclosure of which is incorporated by reference in its entirety as if fully set forth herein.

### TECHNICAL FIELD

The disclosure generally relates to wireless systems. More particularly, the subject matter disclosed herein relates to improvements to integrated sensing and communication (ISAC) in wireless systems.

### SUMMARY

In a wireless system with ISAC, sensing and communication may share the same frequency band and hardware. As wireless technologies, such as massive multiple input-multiple output (MIMO), evolve with more antenna elements and a wider bandwidth in higher frequency bands (e.g., millimeter-wave (mm-wave) bands), they become more reliant on increasingly specific and accurate assistance information (e.g., distance (range), angle, instantaneous velocity, and area of objects).

To solve this problem, wireless sensing technologies aim to acquire information about a remote object without physical contact. The sensing data of the object and its surroundings may then be utilized for analysis so that meaningful information about the object and its characteristics may be obtained with high resolution and reliable accuracy.

Leveraging the strengths of wireless sensing technologies may be advantageous for the development of future wireless communication technologies. Accordingly, the integration of sensing and communication in 5^{th} generation (5G)-Advanced and 6^{th} generation (6G) wireless systems is expected to be beneficial.

One issue with the above approach is that to enable the 5G-Advanced and 6G wireless systems for sensing capability, the beam management framework for sensing may require several enhancements. For example, a gNode B (gNB) may not be aware of a suitable/best beam for transmission or reception. As another example, a beam/spatial filter for radar sensing transmission or reception may not be aligned with a gNB transmission beam of a downlink (DL) reference signal (RS) or a corresponding user equipment (UE) reception (Rx) beam for reception of the DL RS. Thus, the current beam management framework does not provide a suitable support for a radar sensing RS.

To overcome these issues, systems and methods are described herein for performing beam management for sensing in the context of ISAC.

In an embodiment, a method is provided in which a first device in a wireless system receives a first set of sensing RSs over beams from a second device in the wireless system, and performs first beam measurements based on the first set of sensing RSs. The first device transmits, to the second device, a first information report based on the first beam measurements. The first information report includes a first type of sensing information. The first device receives, from the second device, a second set of sensing RSs, performs second beam measurements based on the second set of sensing RSs, and transmits, to the second device, a second information report based on the second beam measurements. The second information report includes a second type of sensing information that is different from the first type of sensing information.

In an embodiment, a wireless system is provided that includes a first device configured to transmit a first set of sensing RSs over beams to a second device in the wireless system. The first device is also configured to receive, from the second device, a first information report including a first type of sensing information, select a target for tracking based on the first information report, and transmit a second set of sensing RSs for tracking the target. The first device is further configured to receive, from the second device, a second information report including a second type of sensing information that is different from the first type of sensing information. The wireless system also includes the second device configured to receive the first set of sensing RSs, perform first beam measurements based on the first set of sensing RSs, transmit the first information report based on the first beam measurements, receive the second set of sensing RSs, perform second beam measurements based on the second set of sensing RSs, and transmit the second information report based on the second beam measurements.

In an embodiment, a first device of a wireless system is provided. The first device includes a processor and a non-transitory computer readable storage medium storing instructions. When executed, the instructions cause the processor to receive a first set of sensing RSs over beams from a second device in the wireless system, perform first beam measurements based on the first set of sensing RSs, and transmit, to the second device, a first information report based on the beam measurements. The first information report comprises a first type of sensing information. The instructions also cause the processor to receive, from the second device, a second set of sensing RSs, perform second beam measurements based on the second set of sensing RSs, and transmit, to the second device, a second information report based on the second beam measurements. The second information report includes a second type of sensing information that is different from the first type of sensing information.

### BRIEF DESCRIPTION OF THE DRAWING

In the following section, the aspects of the subject matter disclosed herein will be described with reference to exemplary embodiments illustrated in the figures, in which:

FIG. 1 is a diagram illustrating sensing modes of a wireless communication system;

FIG. 2 is a diagram illustrating an orthogonal frequency division multiplexing (OFDM)-based sensing frame;

FIG. 3 is a diagram illustrating a message flow for bistatic sensing beam management, according to an embodiment;

FIG. 4 is a diagram illustrating multiple target detection with bistatic radio frequency (RF) sensing, according to an embodiment;

FIG. 5 is a diagram illustrating multiple target detection with bistatic RF sensing, according to another embodiment;

FIG. 6 is a diagram illustrating a message flow for bistatic sensing beam management, according to another embodiment;

FIG. 7 is a flowchart illustrating beamforming for sensing and communication, according to an embodiment;

FIG. 8 is a diagram illustrating an example of interpreting valid or invalid beams configured by a gNB, according to an embodiment;

FIG. 9 is a flowchart illustrating a method for UE-based selection of a transmission (Tx) beam for radar sensing, according to an embodiment; and

FIG. 10 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Wide bandwidths and large antenna arrays may be considered symbols of high-resolution radar systems and modern communication systems. Applicable frequencies have increased in successive generations of communication systems and many key radar bands for high resolution sensing are merging with communication bands. For example, popular radar bands including K (18 gigahertz (GHz)-26.5 GHZ) and Ka (26.5 GHZ-40 GHZ) are close to popular mmWave communication bands. Furthermore, the bandwidth of modern communication systems is fairly large, thereby creating opportunities for ISAC.

Radar technology and wireless telecommunications have coexisted for some time, but efforts have generally concentrated on interference management that enables the two technologies to operate as smoothly as possible without disturbing one another. These efforts have increased infrastructure costs and resulted in spectrum usage inefficiencies.

ISAC refers to the introduction of sensing capability to wireless communication networks. An objective of ISAC is to share the spectrum more efficiently and reuse the existing wireless network infrastructure for sensing. Sensing may refer to “radar-like” functionality (i.e., the ability to detect the presence, movement, and other characteristics of objects under the coverage of the wireless network). However, sensing may also refer to other types of sensing, such as, for example, detection of general characteristics of the environment, local weather conditions, etc.

Compared to the deployment of a separate network providing a sensing functionality, ISAC is beneficial in that the sensing capability may be introduced on large scale at a relatively low incremental cost by piggybacking on infra-structure that is already deployed for communication purposes. A massive communication infrastructure already exists, and an even more dense deployment may be available in future generations of wireless communication, which would allow for enhanced sensing capabilities. Accordingly, it may be possible to enable mono-static radar applications, in which the transmission of a radar signal and the reception of a reflected signal are handled by the same node, as well as various multi-static setups, in which transmission and reception are handled by different collaborating nodes.

If implemented properly, the integration of sensing into a communication network provides for better spectrum utilization when compared to assigning separate spectrum chunks for the two applications.

ISAC has begun to emerge as part of standardization efforts. For example, one such standard aims to use sensing to benefit end user applications (e.g., home security, entertainment, energy management home elderly care, and assisted living). There has also been an increased effort to introduce ISAC in a beyond 5G standard for applications such as traffic monitoring and safety, presence detection, localization and mapping, etc.

Sensing and communication traditionally address completely different sets of use cases and requirements. In its simplest form, sensing uses a known signal that is sent in a particular direction. By analyzing a reflected signal, various parameters such as channel response, target-presence, and target properties (e.g., position, shape, size, velocity, etc.) may be estimated. In contrast, communication key performance indicators include data-rate, latency and reliability. This leads to sensing signal characteristics (e.g., bandwidth, time duration, periodicity, power, etc.) to be different than those used for communication purposes.

There are multiple market segments and verticals in which 5G-Advanced-based sensing services may be beneficial for intelligent transportation, aviation, enterprise, smart city, smart home, smart factories, consumer applications, and public sector. A sensing wireless system, that relies on the same 5G new radio (NR) wireless communication system and infrastructure, offers sensing information that may be utilized to assist wireless communication functionalities, such as, for example, radio resource management, interference mitigation, beam management, mobility, etc. Sensing services and sensing-assisted communications may be more efficient when wireless sensing and communication are integrated in the same wireless channel or environment.

Four use cases that may benefit from ISAC include the perception of blind spots in road traffic areas, the perception of road dynamic information, contactless respiration monitoring, and gesture recognition.

With respect to the perception of blind spots in road traffic areas, a blind spot of a car refers to an area where a driver's line of sight is blocked by obstacles or the car itself and cannot be directly observed by the driver. Sub-use cases may relate to heavy vehicles having large blind spots that cause the most traffic accidents.

With respect to the perception of road dynamic information, this use case may be classified into traffic jam detection and traffic safety risk detection. Severe traffic congestion directly reduces travel efficiency, impacts people's lives, and limits manufactory production, while indirectly increasing air pollution and affecting people's health. Dangerous driving behaviors may be induced by speeding, sharp turns, sudden acceleration, and sudden braking. Current detection that focuses on the acquisition of road dynamic information generally relates to cameras and speed-measuring radars having a limited deployment scope.

With respect to contactless respiration monitoring, respiratory diseases suffered by people worldwide incur a large global health burden, particularly for vulnerable infants and young children. A human's sleep situation may be monitored with 3GPP-based wireless signals.

With respect to gesture recognition, there is flexibility in expressing meanings from portions of the human body, such as a head, a hand, a leg, and a combination of human body parts. Two types of schemes for gesture recognition include device-based and device-free, which correspond to wearable devices and non-wearable devices, respectively. Common sensors for device-based solutions include a camera, a depth camera, a glove, and a wristband, while sensors for device-free solution include radar.

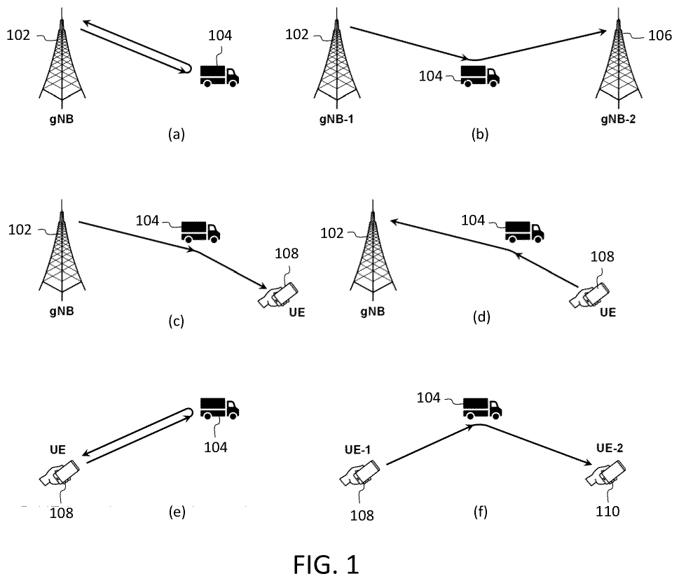

FIG. 1 is a diagram illustrating six sensing modes. A first mode (a) is gNB-based mono-static sensing in which a sensing signal is transmitted from a first gNB 102 and a signal reflected from an object 104 is received by the first gNB 102. A second mode (b) is gNB1-to-gNB2 based bi-static sensing in which a sensing signal is transmitted from the first gNB 102 and a signal reflected from the object 104 is received by a second gNB 106. A third mode (c) is gNB-to-UE-based bi-static sensing in which a sensing signal is transmitted from the first gNB 102 and a signal reflected from the object 104 is received by a first UE 108. A fourth mode (d) is UE-to-gNB-based bi-static sensing in which a sensing signal is transmitted from the first UE 108 and a reflected signal from the object 104 is received by the first gNB 102. A fifth mode (c) is UE-based mono-static sensing in which a sensing signal is transmitted from the first UE 108 and a reflected signal from the object 104 is received by the first UE 108. A sixth mode (f) is UE1-to-UE2-based bi-static sensing in which a sensing signal is transmitted from the first UE 108 and a reflected signal from the object 104 is received by a second UE 110. Several sensing modes may also be used together.

In a typical radar-like scenario, there are requirements for certain parameters. These parameters include range resolution (Rr), which is a minimum distance between two objects that is distinguishable by a radar, unambiguous range (Ru), which is a maximum range that an object can be unambiguously detected, velocity resolution (vr), which is a minimum change in speed that can be measured by the radar, and unambiguous velocity (vu), which is a maximum range of speed (vmax-vmin) that can be measured by the radar. Based on these parameters, there are requirements on the duration, bandwidth, and periodicity of the sensing signal.

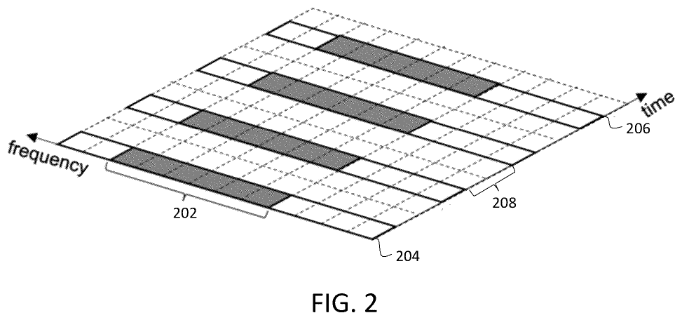

FIG. 2 is a diagram illustrating an OFDM-based sensing frame. A bandwidth (BW) 202 of a sensing signal is shown along a frequency at a given time. The sensing frame begins at an initial time Tᵢₙₜ 204 and ends at a final time T_{f} 206 of the sensing frame duration, with a gap Tᵣ 208 between sensing signals in the sensing frame.

Table 1 shows the relationship between sensing signal parameters and sensing requirements.

TABLE 1

| | |
|---|---|
| Minimum bandwidth | BWₘᵢₙ = c/2Rᵣ |
| Minimum gap between sensing signals | T_{r min} = 2Rᵤ/c |
| Maximum gap between sensing signals | T_{r max} = c/4f_{c}vᵤ |
| Minimum sensing frame duration | T_{f min} = c/2f_{c}vᵣ |

In NR, beam management is defined as a set of L1/L2 procedures to acquire and maintain a set of transmission and reception points (TRPs) and/or UE beams that can be used for DL and UL transmission/reception. These procedures include at least beam determination in which TRP(s) or a UE select its own Tx/Rx beam(s), beam measurement in which TRP(s) or a UE measures characteristics of received beamformed signals, beam reporting in which a UE reports information of beamformed signal(s) based on beam measurement, and beam sweeping in which a spatial area is covered with beams transmitted and/or received during a time interval in a predetermined way.

Tx/Rx beam correspondence at the TRP holds if at least one of the following is satisfied. The TRP is able to determine a TRP Rx beam for the uplink reception based on UE's downlink measurement on the TRP's one or more Tx beams, and the TRP is able to determine a TRP Tx beam for the downlink transmission based on the TRP's uplink measurement on the TRP's one or more Rx beams.

Tx/Rx beam correspondence at the UE holds if at least one of the following is satisfied. The UE is able to determine a UE Tx beam for the uplink transmission based on the UE's downlink measurement on the UE's one or more Rx beams, the UE is able to determine a UE Rx beam for the downlink reception based on the TRP's indication based on uplink measurement on the UE's one or more Tx beams, and a capability indication of UE beam correspondence-related information to the TRP is supported.

Several DL L1/L2 beam management procedures may be supported within one or multiple TRPs.

P-1 is a first beam management procedure used to enable UE measurement on different TRP Tx beams to support selection of TRP Tx beams/UE Rx beam(s). For beamforming at the TRP, it typically includes an intra/inter-TRP Tx beam sweep from a set of different beams. For beamforming at a UE, it typically includes a UE Rx beam sweep from a set of different beams.

P-2 is a second beam management procedure used to enable UE measurement on different TRP Tx beams to possibly change inter/intra-TRP Tx beam(s). P2 is from a possibly smaller set of beams for beam refinement than in P-1. P-2 may be a special case of P-1.

P-3 is a third beam management procedure used to enable UE measurement on the same TRP Tx beam to change UE Rx beam in the case the UE uses beamforming.

Network triggered aperiodic beam reporting may be supported under P-1, P-2, and P-3 related operations.

Typically, a single direction is considered for communication only. However, the directions of the sensing beam and the communication beam may be different. Therefore, there is a need for a new beam determination procedure for ISAC in which the direction of the beam for communication and the direction of the beam for sensing may be determined.

To enable 5G NR and 6G for sensing capability, several system design enhancements may be needed (e.g., enhancements to the beam management framework). For various radar sensing applications, the gNB may not be aware of a suitable/best beam for transmission or reception. In some cases, a beam/spatial filter for radar sensing transmission or reception may not be aligned with (e.g., quasi co-located (QCL) with) a gNB Tx beam of any DL reference signal, or a corresponding UE Rx beam for reception of such a DL RS. For example, a spatial relation information configuration for a sounding reference signal (SRS) may be based on a synchronization signal block (SSB) associated with a serving cell or a neighbor cell, or a serving cell channel state information (CSI)-RS, or a DL-positioning RS (PRS), all of which mainly target UE-gNB/TRP directions and may be less relevant for radar sensing applications. Thus, current beam management may not provide suitable support for a radar sensing RS.

Additionally, radar sensing may assist the beam management procedure.

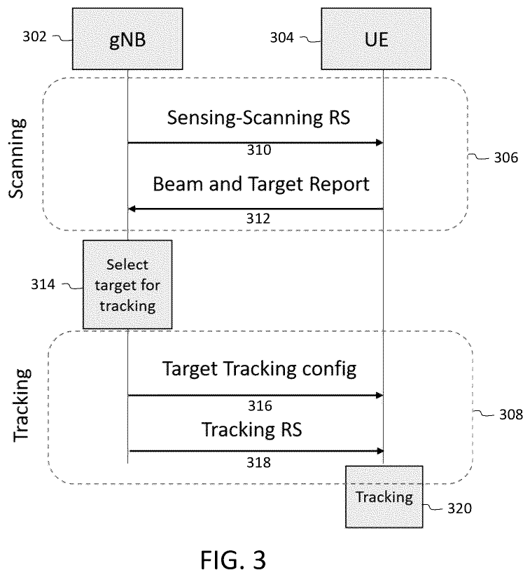

FIG. 3 is a diagram illustrating a message flow for bistatic sensing beam management, according to an embodiment. A gNB 302 is the sensing signal transmitter and a UE 304 is the sensing signal receiver. A similar signaling procedure may be designed for the case where the UE 304 is the sensing signal transmitter and the gNB 302 is the sensing signal receiver.

At high frequencies, OFDM symbols are beam-formed and sensing must be performed in several directions. Therefore, the overhead for sensing can become quite large. Depending on the beamforming solution and the angular range that is covered in sensing, overhead may be further increased.

To reduce the overhead, a two-stage solution is provided herein. In a first scanning stage 306, the environment is sensed with a shorter sensing frame and/or smaller sensing bandwidth, which provides a rough picture of the environment. Based on this rough sensing in the scanning stage 306, if an object is detected, then a full frame of a sensing signal, with the required bandwidth and periodicity, may locate the object and measure the speed more accurately, in a second tracking stage 308. Specifically, the beam direction for Tx and Rx is determined for each target (target group) in the scanning stage 306, and in the tracking stage 308, the Tx and Rx re-use the beam direction for a given target determined in the scanning stage 306. The scanning stage 306 essentially forms the beam direction between Tx and target, and the beam direction between Rx and target. In the tracking stage 308, Tx and Rx sends the full RS to obtain an accurate estimation of the target. Thus, beam sweeping is only performed in the scanning stage.

For the sensing part of the ISAC beam management protocol, the scanning stage 306 is defined as a phase where a gNB and/or a UE performs object detections (one shot detection of the object's position by ranging and angle of arrival and/or velocity), which provides a rough sensing of the objects. The scanning stage also provides a Tx beam direction at the gNB and an Rx beam direction at the UE for tracking given target(s) in the next stage. The Tx beam and Rx beam may correspond to a broad beam width, such as a P1 SSB beam in the communications, or may correspond to a narrow beam width, such as P2 and P3 CSI-RS beams in the communications.

The tracking stage 308 is defined as a phase in which the gNB and/or the UE perform object tracking on a set of selected objects. A full frame of the sensing signal with the required bandwidth and periodicity may provide accurate sensing of the objects by using the Tx and Rx beam directions per target object obtained from scanning stage 306. The UE may measure accurate parameters per target object such as, range, angle of arrival, and velocity. The UE may optionally report the measurement results to the gNB.

Two different sets of RSs are defined herein. Tracking RSs may be QCLed type-D with the scanning RSs. A scanning RS may be SSB, PRS, or CSI-RS reference signals, or a new sensing scanning RS, whereas the tracking RS may be CSI-RS or PRS, or a new sensing tracking RS.

While sensing is performed, the UE may communicate with another entity (e.g., a gNB or another UE). Thus, the UE may also exchange information with the gNB, using a different beam than the sensing beam.

The message flow of FIG. 3 represents a portion of the signals exchanged between the base station (e.g., a gNB) and the UE during the scanning stage 306 and the tracking stage 308. The gNB 302 may transmit a DL scanning-sensing reference signal (SSRS) 310, such as an SSB, a PRS, or a CSI-RS signal. The UE 304 may send a beam and target information report 312 based on measurements associated with the received SSRS. The report may include signal values (e.g., reference signals received power (RSRP), reference signal received quality (RSRQ), and a signal interference and noise ratio (SINR)) exceeding a threshold and target identification information if multiple targets are detected. The UE 304 may also include receive beam identification information in the report, and the gNB 302 may assign different target identification values based on this information. The report may be sent via radio resource control (RRC) messaging or another type of UL signaling. The beam and target information report may include, for example, one or more of the RSRP, RSRQ, or SINR values associated with the SSRS, which exceed a threshold value and target identification information if multiple targets are detected. For example, the target information may be generated by the UE 304 based on objects detected by different receive beams, such as the first target detected by the first receive beam, and the second target detected by the third receive beam. The UE 304 may include receive beam identification information in the beam and target information report, and the base station may be configured to assign different target identification values based on the received beam identification information. The beam identification of the Tx beam or Rx beam may be a transmission configuration indication (TCI) state configured per beam. A detected target may be identified by a pair of Tx beam and Rx beam via their TCI states. In addition, the beam and target report may include target specific sensing measurements that identify a target or a target group (e.g., doppler/velocity, delay/range, angle). Table 2 shows an example of a target information report.

TABLE 2

| | Tx | Rx | Doppler/ | Delay/ | Angle of | RSRP/ |
|---|---|---|---|---|---|---|
| | beam | beam | velocity | range | Arrival | RSRQ |
| Target group 1 | TCI | TCI | Delta_f1 | t1 | x | a |
| | state1 | state5 | | | | |
| Target group 2 | TCI | TCI | Delta_f2 | t2 | y | b |
| | state2 | state6 | | | | |
| Target group 3 | TCI | TCI | Delta_f3 | t3 | z | c |
| | state3 | state7 | | | | |
| Target group 4 | TCI | TCI | Delta_f4 | t4 | r | d |
| | state4 | state8 | | | | |

After the scanning stage 306, the gNB 302 may select targets for tracking based on the beam and target information report from the UE, at 314. Additional gNBs and UEs may be used for scanning and tracking. In the tracking stage 308, the gNB 302 transmits tracking and target configuration information 316 for the selected targets. This information may include the sensing tracking reference signal (STRS) 318 associated with the targets. In particular, the sensing reference signal 318 may be sent with a specific beam towards the target with high density in the time domain or high bandwidth to obtain a more accurate estimation of the target parameters. The UE 304 may track the targets associated with the STRS at 320.

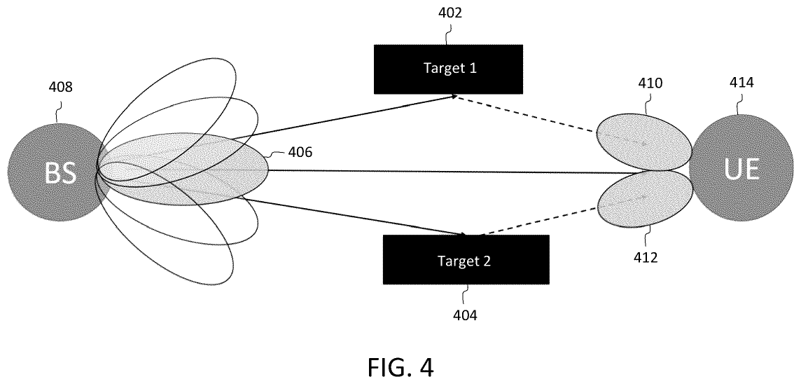

FIG. 4 is a diagram illustrating multiple target detection with bistatic RF sensing, according to an embodiment. Specifically, according to FIG. 4, multiple targets 402 and 404 are detected with a single RS 406 from a BS or gNB 408 and different receive beams 410 and 412 at a UE 414.

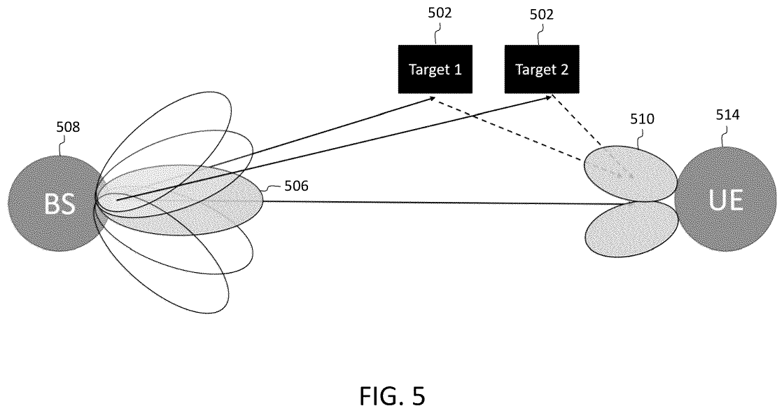

FIG. 5 is a diagram illustrating multiple target detection with bistatic RF sensing, according to another embodiment. Specifically, according to FIG. 5, multiple targets 502 and 504 are detected with a single RS 506 from a BS or gNB 508 and a single receive beam 510 at a UE 514. In this case, the UE 514 may be assigned a target group identification to identify the first and second targets as a target group. The UE may resolve a target group into separate targets based on channel taps or a cluster of channel taps (one cluster corresponds to one multiple path), or an angle of arrival of the sensing signal as indicated in Table 2.

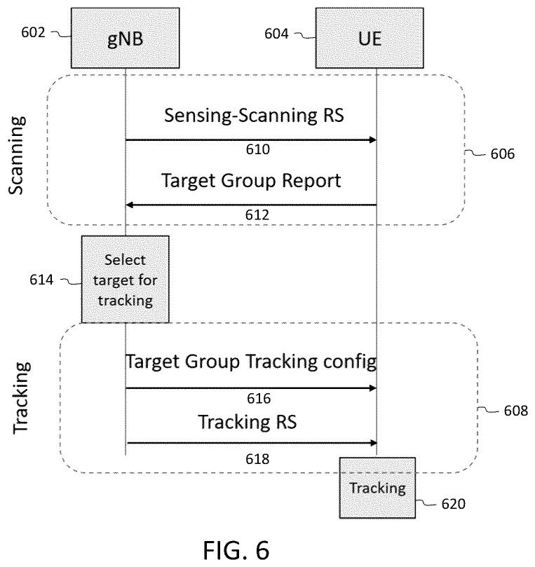

FIG. 6 is a diagram illustrating a message flow for bistatic sensing beam management, according to another embodiment. The message flow between a gNB 602 and a UE 604 of FIG. 6 functions similarly to that of FIG. 3 However, in the scanning stage 606, the gNB 602 is able to detect a group of targets. Specifically, the gNB 602 transmits an SSRS 610 to the UE 604, and the UE 604 transmits a target group report 612 to the gNB 602. The gNB 602 may not necessarily differentiate different targets at 614, since they may need qualities other than RSRP (e.g., delay tab, angle of arrival) to identify an individual target. The identification of an individual target may be during the tracking stage 608, where the UE 604 reports the identified individual target by reporting the identified different angles of arrivals or delay tabs. Specifically, the gNB 602 transmits target group tracking configuration information 616 and a tracking RS 618 to the UE 604, and the UE performs tracking at 620.

During UE or target mobility, a beam switch may be performed to maintain target tracking. For example, when the measured RSRP/RSRQ of the tracking beam signal is less than a threshold, the UE may report it to the gNB. Then, the gNB may activate a new tracking beam and indicate it to the UE.

Additionally, in the tracking stage 608, the UE 604 may more accurately measure each target or target group for metrics such as time domain channel impulse response (i.e., multipath propagation delay vs the received signal power) for each Tx and Rx beam pair, the range-doppler-angular (R-D-A) map, which may be up to four-dimension image data consisting of range, Doppler, azimuth, and elevation. By detecting the area of higher energy on the R-D-A map, it may be possible to determine a location where there is a target or target group. In the tracking stage 608, the UE 604 may report the target related parameters to the gNB 602 as indicated in Table 2 above, after target detection processing of the R-D-A maps.

In another embodiment, depending on the sensing application, the scanning stage 606 and the tracking stage 608 may be performed in parallel at the gNB 602. The gNB 602 and the UE 604 may be tracking multiple target groups while scanning for any new targets.

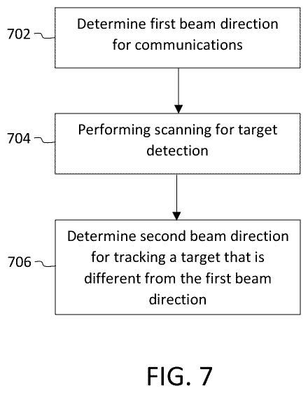

FIG. 7 is a flowchart illustrating beamforming for sensing and communication, according to an embodiment. The beamforming for communication may be performed prior to the beamforming for sensing to facilitate the set-up of the sessions and configuration for the sensing operation. Referring to FIG. 7, at 702, a first beam direction may be determined for communications. At 704, scanning may be performed for target detection. At 706, a second beam direction may be determined for tracking a target. The second beam direction may be different from the first beam direction.

In beam management for radar sensing where a UE is the sensing signal transmitter, the UE's selection of a Tx beam or spatial relation for radar sensing RSs is important. This selection may be based on the specific radar sensing application or category. For example, the UE may take into account radar sensing characteristics such as the desired field of view, angular resolution, and accuracy, as well as the number, density, and geographical distribution of target objects for sensing. Additionally, properties related to beam steering, beam sweeping, periodicity, and repetition may influence the selection process. The UE may establish a linkage between the selected Tx beam or spatial relation and the corresponding radar sensing category or characteristics. This linkage may be established through configuration provided by the gNB, implemented within the UE itself, or a combination of both. This may be applicable to UE mono-static sensing and bi-static sensing between gNB Rx and Tx UE.

For bi-static sensing between gNB Tx and Rx UE, the Rx UE may be configured by the gNB with a set of Rx beams for sensing signal reception and may perform sensing reporting. The Rx UE may select a sub-set of Tx beams from a gNB configured set of Rx beams for receiving sensing RS, and may take into account radar sensing characteristics such as the desired field of view, angular resolution, and accuracy, as well as the number, density, and geographical distribution of target objects for sensing. For bi-static sensing between Tx UE and Rx UE, the Tx and Rx UEs may both be configured by the gNB with a set of Rx beams for sensing signal reception. Both the Tx and Rx UEs may select a sub-set of Tx beams from a gNB-configured set of Tx and Rx beams for a Tx and Rx sensing RS, and may take into account radar sensing characteristics such as the desired field of view and angular resolution.

The gNB may specifically configure a set of valid beams or spatial relations for sensing RS Tx and Rx. For example, a set of valid beams/spatial relations refers to a case in which the Tx UE may send sensing RS by employing the gNB's subset of DL SSB or CSI-RS signals as the QCL source signals. Similarly, the Rx UE may receive the sensing RS by employing the gNB's subset of DL SSB or CSI-RS signals or UL SRS signals as the QCL source signals. From this set, the Tx and/or Rx UE may select an appropriate beam for radar sensing based on the configured options. The set of valid beams may ensure that the UE's radar sensing transmission does not cause interference to other UEs.

For example, when time/frequency resources for radar sensing transmission overlap with resources used for DL/UL/SL communication and sensing by other UEs, spatial separation may be achieved by restricting the set of valid beams to those directions where minimal or no interference occurs with another UEs' communication. In another example, the gNB may also indicate to the UE a set of invalid beams or spatial relations specifically for sensing RS Tx and Rx at the UE, where the UE should use any other beams except those invalid beams configured by the gNB to minimize the inter-cell interference to other UEs. The set of beams, except invalid beams indicated by gNB that the UE can use, may include those beams that do not exist in a gNB-to-UE link for communication signals. This indicates that the sensing RS transmitted by the UE does not necessarily QCLed type D with any of the existing beams at the gNB for communication signals. Further, the gNB may provide assistance information to the UE to aid in the selection of a beam or spatial relation for sensing RS. This assistance may be in the form of a set of beam directions for DL/UL/SL communication or radar sensing transmissions/receptions corresponding to nearby UEs. With this information, the UE may choose radar sensing Tx beams that minimize interference caused by other UEs or consider the presence of interference during measurements or signal detections.

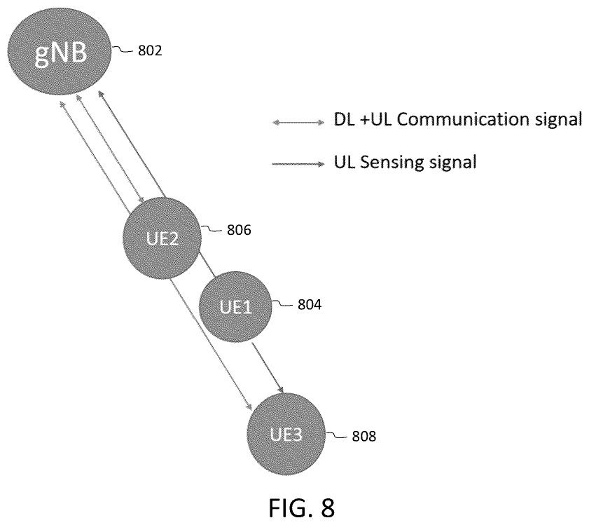

FIG. 8 is a diagram illustrating an example of interpreting valid or invalid beams configured by a gNB, according to an embodiment. The valid or invalid beams may be configured by a gNB 802 due to the interference of existing communication signals. The gNB 802 may indicate the UL beam direction of a second UE (UE2) 806 and a third UE (UE3) 808 for UL transmission. These UL beam directions may be considered the invalid beams for UL sensing signal transmission at first UE (UE1) 804, depending on the Tx power of sensing signal and the relative location between the first UE 804 and the second UE 806/third UE 808. Additionally, the beam direction from the first UE 804 and the third UE 808 may be an invalid beam that is not defined by the TCI framework.

Interpreting a valid/invalid indication from the gNB 802 to resolve this issue may require the first UE 804 to interpret the direction of the indicated beam as the extension of gNB's DL beam, as if the first UE 804 is the extension of the gNB 802. When the gNB 802 indicates a DL beam as ‘invalid’, the first UE 804 may interpret the beam direction from first UE 804 to the third UE 808 as invalid for sensing, and not the direction from first UE 804 to the second UE 806. Specifically, when the gNB 802 indicates the DL beam as an invalid beam for the first UE 804 based on the UL sensing signal, the first UE 804 may interpret this invalid beam direction as the DL Rx beam direction+180 degree.

Alternatively, neighboring UEs may also offer assistance information or configure the valid/allowed set of beams for the UE's sensing RS. This may be achieved through sidelink control information (SCI) provided by a second UE. In such cases, the neighbor UE may utilize its own sensing measurements or sensing results to determine suitable beams for radar sensing by other UEs. The neighbor UE may then provide this information as assistance to the UE. Additionally, a neighbor UE may share its original sensing measurements or results, either in raw form or based on predetermined processing, as assistance information to the UE. This information may be conveyed through sidelink feedback control information (SFCI) over a physical sidelink feedback channel (PSFCH).

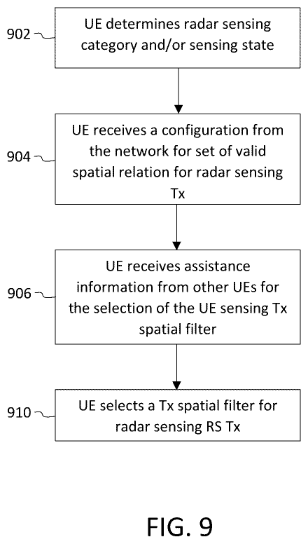

FIG. 9 is a flowchart illustrating a method for UE-based selection of a Tx beam for radar sensing, according to an embodiment. This selection process may take into account various factors, including the sensing application category, the gNB's configuration of valid beams, and the assistance information provided by neighboring UEs.

At 902, the UE may determine the radar sensing category and/or characteristics. This determination may be based on factors such as target angular resolution and accuracy. By considering these parameters, the UE may gain insight into specific requirements of the radar sensing application.

At 904, the UE may receive a configuration from the network, which defines a set of valid spatial relations for radar sensing transmission. This configuration may be provided by the gNB and serves as a guideline for the UE's beam selection process. It ensures that the UE operates within predefined spatial constraints that minimize interference with other UEs and maximize overall system efficiency.

Additionally, the UE may benefit from assistance information received from other UEs, at 906. This assistance information may include or be based on sensing measurements performed by neighboring UEs. By sharing their findings, neighboring UEs contribute to the UE's decision-making process regarding the selection of the sensing Tx spatial filter. This collaborative approach may enhance the overall accuracy and effectiveness of radar sensing.

Based on the determined sensing category/characteristics, the received configuration of valid spatial relations, and the assistance information, the UE may select a Tx spatial filter for radar sensing RS transmission, at 908. This selection process may ensure that the chosen Tx beam aligns with the specific requirements of the radar sensing application. It takes into account the available spatial resources, neighboring UEs' interference patterns, and any adjustments required for non-line-of-sight (NLOS) radar sensing scenarios.

The UE's selection of the Rx beam/spatial relation/TCI state for radar sensing reception is also a crucial aspect of the overall process. This selection process, which may be partially guided by the gNB's configuration or indications from other UEs, may determine the Rx beam used for receiving radar sensing signals. The UE may use the same Rx beam as the one used for transmission (in the case of a shared antenna panel/array) or employ a different antenna panel/array for reception purposes. Adjustments to the Rx beam may be necessary to account for variations in the radar sensing environment. The UE's implementation and assistance information received from the gNB or neighboring UEs play a role in determining the optimal Rx beam for radar sensing reception.

As illustrated in FIG. 9, a detailed process is provided for UE-based selection of the Tx beam for radar sensing transmission. By considering the sensing application category, a gNB configuration, and assistance information from neighboring UEs, the UE may make informed decisions to optimize radar sensing performance. Similarly, the selection of the Rx beam for radar sensing reception considers the specific requirements of the radar sensing scenario, incorporating assistance information and adapting to the radar environment.

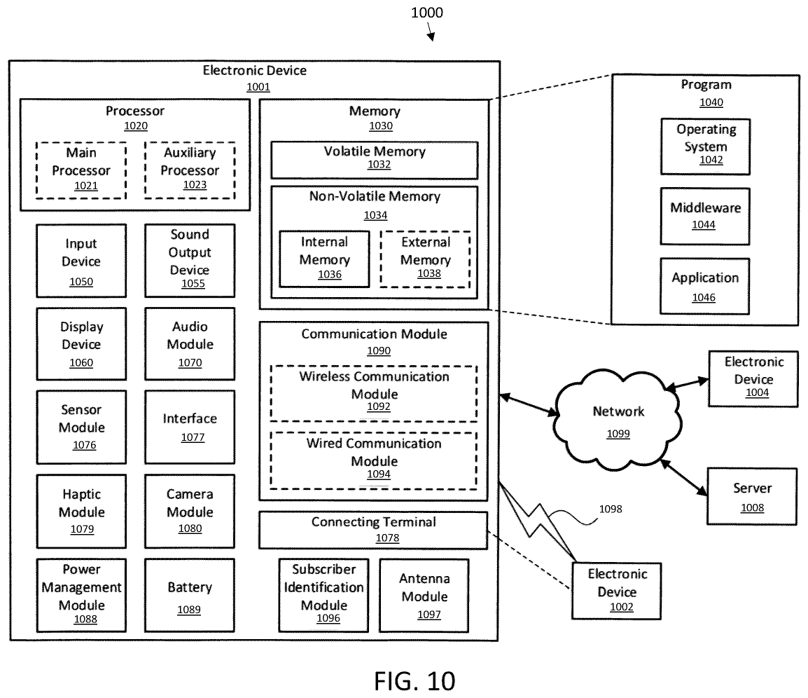

FIG. 10 is a block diagram of an electronic device in a network environment 1000, according to an embodiment.

Referring to FIG. 10, an electronic device 1001 in a network environment 1000 may communicate with an electronic device 1002 via a first network 1098 (e.g., a short-range wireless communication network), or an electronic device 1004 or a server 1008 via a second network 1099 (e.g., a long-range wireless communication network). The electronic device 1001 may communicate with the electronic device 1004 via the server 1008. The electronic device 1001 may include a processor 1020, a memory 1030, an input device 1050, a sound output device 1055, a display device 1060, an audio module 1070, a sensor module 1076, an interface 1077, a haptic module 1079, a camera module 1080, a power management module 1088, a battery 1089, a communication module 1090, a subscriber identification module (SIM) card 1096, or an antenna module 1097. In one embodiment, at least one (e.g., the display device 1060 or the camera module 1080) of the components may be omitted from the electronic device 1001, or one or more other components may be added to the electronic device 1001. Some of the components may be implemented as a single integrated circuit (IC). For example, the sensor module 1076 (e.g., a fingerprint sensor, an iris sensor, or an illuminance sensor) may be embedded in the display device 1060 (e.g., a display).

The processor 1020 may execute software (e.g., a program 1040) to control at least one other component (e.g., a hardware or a software component) of the electronic device 1001 coupled with the processor 1020 and may perform various data processing or computations.

As at least part of the data processing or computations, the processor 1020 may load a command or data received from another component (e.g., the sensor module 1076 or the communication module 1090) in volatile memory 1032, process the command or the data stored in the volatile memory 1032, and store resulting data in non-volatile memory 1034. The processor 1020 may include a main processor 1021 (e.g., a central processing unit (CPU) or an application processor (AP)), and an auxiliary processor 1023 (e.g., a graphics processing unit (GPU), an image signal processor (ISP), a sensor hub processor, or a communication processor (CP)) that is operable independently from, or in conjunction with, the main processor 1021. Additionally or alternatively, the auxiliary processor 1023 may be adapted to consume less power than the main processor 1021, or execute a particular function. The auxiliary processor 1023 may be implemented as being separate from, or a part of, the main processor 1021.

The auxiliary processor 1023 may control at least some of the functions or states related to at least one component (e.g., the display device 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). The auxiliary processor 1023 (e.g., an image signal processor or a communication processor) may be implemented as part of another component (e.g., the camera module 1080 or the communication module 1090) functionally related to the auxiliary processor 1023.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034. Non-volatile memory 1034 may include internal memory 1036 and/or external memory 1038.

The program 1040 may be stored in the memory 1030 as software, and may include, for example, an operating system (OS) 1042, middleware 1044, or an application 1046.

The input device 1050 may receive a command or data to be used by another component (e.g., the processor 1020) of the electronic device 1001, from the outside (e.g., a user) of the electronic device 1001. The input device 1050 may include, for example, a microphone, a mouse, or a keyboard.

The sound output device 1055 may output sound signals to the outside of the electronic device 1001. The sound output device 1055 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1060 may visually provide information to the outside (e.g., a user) of the electronic device 1001. The display device 1060 may include, for example, a display, a hologram device, or a projector and control circuitry to control a corresponding one of the display, hologram device, and projector. The display device 1060 may include touch circuitry adapted to detect a touch, or sensor circuitry (e.g., a pressure sensor) adapted to measure the intensity of force incurred by the touch.

The audio module 1070 may convert a sound into an electrical signal and vice versa. The audio module 1070 may obtain the sound via the input device 1050 or output the sound via the sound output device 1055 or a headphone of an external electronic device 1002 directly (e.g., wired) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. The sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device 1002 directly (e.g., wired) or wirelessly. The interface 1077 may include, for example, a high-definition multimedia interface (HDMI), a universal serial bus (USB) interface, a secure digital (SD) card interface, or an audio interface.

A connecting terminal 1078 may include a connector via which the electronic device 1001 may be physically connected with the external electronic device 1002. The connecting terminal 1078 may include, for example, an HDMI connector, a USB connector, an SD card connector, or an audio connector (e.g., a headphone connector).

The haptic module 1079 may convert an electrical signal into a mechanical stimulus (e.g., a vibration or a movement) or an electrical stimulus which may be recognized by a user via tactile sensation or kinesthetic sensation. The haptic module 1079 may include, for example, a motor, a piezoelectric element, or an electrical stimulator.

The camera module 1080 may capture a still image or moving images. The camera module 1080 may include one or more lenses, image sensors, image signal processors, or flashes. The power management module 1088 may manage power supplied to the electronic device 1001. The power management module 1088 may be implemented as at least part of, for example, a power management integrated circuit (PMIC).

The battery 1089 may supply power to at least one component of the electronic device 1001. The battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the AP) and supports a direct (e.g., wired) communication or a wireless communication. The communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as BLUETOOTH™, wireless-fidelity (Wi-Fi) direct, or a standard of the Infrared Data Association (IrDA)) or the second network 1099 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The antenna module 1097 may transmit or receive a signal or power to or from the outside (e.g., the external electronic device) of the electronic device 1001. The antenna module 1097 may include one or more antennas, and, therefrom, at least one antenna appropriate for a communication scheme used in the communication network, such as the first network 1098 or the second network 1099, may be selected, for example, by the communication module 1090 (e.g., the wireless communication module 1092). The signal or the power may then be transmitted or received between the communication module 1090 and the external electronic device via the selected at least one antenna.

Commands or data may be transmitted or received between the electronic device 1001 and the external electronic device 1004 via the server 1008 coupled with the second network 1099. Each of the electronic devices 1002 and 1004 may be a device of a same type as, or a different type, from the electronic device 1001. All or some of operations to be executed at the electronic device 1001 may be executed at one or more of the external electronic devices 1002, 1004, or 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1001. The electronic device 1001 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
receiving, at a first device in a wireless system, a first set of sensing reference signals (RSs) over beams from a second device in the wireless system;
performing first beam measurements, by the first device, based on the first set of sensing RSs;
transmitting, from the first device, to the second device, a first information report based on the first beam measurements, wherein the first information report comprises a first type of sensing information;
receiving, by the first device, from the second device, a second set of sensing RSs;
performing second beam measurements, by the first device, based on the second set of sensing RSs; and
transmitting, from the first device, to the second device, a second information report based on the second beam measurements, wherein the second information report comprises a second type of sensing information that is different from the first type of sensing information.

2. The method of claim 1, wherein the first set of sensing RSs has a shorter frame or a smaller sensing bandwidth than the second set of sensing RSs.

3. The method of claim 1, further comprising:
communicating with the second wireless device using a communication beam.

4. The method of claim 1, wherein:
the beams are selected from a set of beams based on a radar sensing category or one or more radar sensing characteristics; and
the set of beams avoid interference with one or more other devices in the wireless system.

5. The method of claim 4, wherein the one or more radar sensing characteristics comprise at least one of a field of view, an angular resolution, an accuracy, a number of targets to be tracked, a density of targets to be tracked, and a geographical distribution of targets to be tracked.

6. The method of claim 1, wherein the first set of sensing RSs comprises synchronization signal blocks (SSBs), positioning RS (PRSs), or channel state information (CSI)-RSs.

7. The method of claim 1, wherein:
the first type of sensing information comprises information for a detected target group comprising at least one of a transmit beam identifier (ID), a receive beam ID, a velocity, a range, an angle of arrival, and a reference signal received power (RSRP) or reference signal received quality (RSRQ); and
the second type of sensing information comprises at least one of a time domain channel impulse response for each transmit-receive beam pair, and a range-doppler-azimuth (R-D-A) map.

8. The method of claim 1, wherein receiving the second set of sensing RSs comprises:
receiving, at the first device, from the second device, configuration information for a target; and
receiving, at the first device, from the second device, the second set of sensing RSs associated with the target.

9. A wireless system comprising:
a first device configured to:
transmit a first set of sensing reference signals (RSs) over beams to a second device in the wireless system;
receive, from the second device, a first information report comprising a first type of sensing information;
select a target for tracking based on the first information report;
transmit a second set of sensing RSs for tracking the target; and
receive, from the second device, a second information report comprising a second type of sensing information that is different from the first type of sensing information; and
the second device configured to:
receive the first set of sensing RSs;
perform first beam measurements based on the first set of sensing RSs;
transmit the first information report based on the first beam measurements;
receive the second set of sensing RSs;
perform second beam measurements based on the second set of sensing RSs; and
transmit the second information report based on the second beam measurements.

10. The wireless system of claim 9, wherein the first set of sensing RSs has a shorter frame or a smaller sensing bandwidth than the second set of sensing RSs.

11. The wireless system of claim 9, wherein:
the beams are selected from a set of beams based on a radar sensing category or one or more radar sensing characteristics; and
the set of beams avoid interference with one or more other devices in the wireless system.

12. The wireless system of claim 11, wherein the one or more radar sensing characteristics comprise at least one of a field of view, an angular resolution, an accuracy, a number of targets to be tracked, a density of targets to be tracked, and a geographical distribution of targets to be tracked.

13. The wireless system of claim 9, wherein the first set of sensing RSs comprises synchronization signal blocks (SSBs), positioning RSs (PRSs) or channel state information (CSI)-RSs.

14. The wireless system of claim 9, wherein:
the first type of sensing information comprises information for a detected target group comprising at least one of a transmit beam identifier (ID), a receive beam ID, a velocity, a range, an angle of arrival, and a reference signal received power (RSRP) or reference signal received quality (RSRQ); and
the second type of sensing information comprises at least one of a time domain channel impulse response for each transmit-receive beam pair, and a range-doppler-azimuth (R-D-A) map.

15. The wireless system of claim 9, wherein:
in transmitting the second set of sensing RSs, the first device is further configured to:
transmit configuration information for a target; and
transmit the second set of sensing RSs associated with the target; and
the second device is further configured to:
receive the configuration information and the second set of sensing RSs; and
perform tracking measurements for the target based on the configuration information and the second set of sensing RSs.

16. A first device of a wireless system, the first device comprising:
a processor; and
a non-transitory computer readable storage medium storing instructions that, when executed, cause the processor to:
receive a first set of sensing reference signals (RSs) over beams from a second device in the wireless system;
perform first beam measurements based on the first set of sensing RSs;
transmit, to the second device, a first information report based on the first beam measurements, wherein the first information report comprises a first type of sensing information;
receive, from the second device, a second set of sensing RSs;
perform second beam measurements based on the second set of sensing RSs; and
transmit, to the second device, a second information report based on the second beam measurements, wherein the second information report comprises a second type of sensing information that is different from the first type of sensing information.

17. The first device of claim 16, wherein the first set of sensing RS has a shorter frame or a smaller sensing bandwidth than the second set of sensing RSs.

18. The first device of claim 16, wherein:
the beams are selected from a set of beams based on a radar sensing category or one or more radar sensing characteristics; and
the set of beams avoid interference with one or more other devices in the wireless system.

19. The first of claim 18, wherein the one or more radar sensing characteristics comprise at least one of a field of view, an angular resolution, an accuracy, a number of targets to be tracked, a density of targets to be tracked, and a geographical distribution of targets to be tracked.

20. The first device of claim 16, wherein, in receiving the second set of sensing RSs, the instructions further cause the processor to:
receive configuration information for a target; and
receive, from the second device, the second set of sensing RSs associated with the target.
